(19) United States
(12) Patent Application Publication
(10) Pub. No.: US 2024/0290995 A1
(43) Pub. Date: Aug. 29, 2024

(54) METHOD FOR PRODUCING AN ELECTROCHEMICAL CELL UNIT

(71) Applicant: Robert Bosch GmbH, Stuttgart (DE)

(72) Inventors: Andreas Ringk, Bamberg (DE); Anton Ringel, Bamberg (DE)

(21) Appl. No.: 18/570,226

(22) PCT Filed: Jun. 14, 2022
(86) PCT No.: PCT/EP2022/066072

§ 371 Date: Dec. 14, 2023

(30) Foreign Application Priority Data
Jun. 17, 2021 (DE) 10 2021 206 208.3

(51) Int. Cl. H01M 8/0297; H01M 8/0232; H01M 8/0234; H01M 8/2404; H01M 8/248

(52) U.S. Cl. CPC H01M 8/0297; H01M 8/0232; H01M 8/0234; H01M 8/2404; H01M 8/248

(57) ABSTRACT

A method for producing an electrochemical cell unit (53) for converting electrochemical energy into electric energy in the form of a fuel cell unit (1) and/or for converting electric energy into electrochemical energy in the form of an electrolysis cell unit (49), comprising stacked electrochemical cells (52). The method has the steps of: providing layered components (5, 6, 7, 8, 9, 10, 30, 51) of the electrochemical cells (52), namely preferably proton exchange membranes (5), anodes (7), cathodes (8), gas diffusion layers (9), and bipolar plates (10), and stacking the layered components (5, 6, 7, 8, 9, 10, 30, 51) in order to form electrochemical cells (52) and in order to form a stack of the electrochemical cell unit (53), wherein the gas diffusion layers (9) are provided such that the gas diffusion layers (9) comprise a magnetic material.

### BACKGROUND

The present invention relates to a method of producing an electrochemical cell unit and an electrochemical cell unit.

Fuel cell units as galvanic cells convert continuously supplied fuel and oxidizing agent into electrical energy and water by means of redox reactions at an anode and cathode. Fuel cells are used in a wide variety of stationary and mobile applications, for example in houses without a connection to the electricity grid or in motor vehicles, rail transport, aviation, space travel and shipping. In fuel cell units, a large number of fuel cells are arranged in a stack.

In fuel cell units, a large number of fuel cells are arranged in a fuel cell stack. Inside each fuel cell there is a gas chamber for oxidizing agents, i.e. a flow chamber for passing through oxidizing agents, such as air from the surroundings with oxygen. The gas chamber for oxidizing agents is formed by ducts on the bipolar plate and by a gas diffusion layer for a cathode. The ducts are thus formed by a corresponding duct structure of a bipolar plate and the oxidizing agent, namely oxygen, reaches the cathode of the fuel cells through the gas diffusion layer. Similarly, there is a gas chamber for fuel.

Electrolysis cell units consisting of stacked electrolysis cells, similar to fuel cell units, are used for the electrolytic production of hydrogen and oxygen from water, for example. Furthermore, fuel cell units are known which can be operated as reversible fuel cell units and thus as electrolysis cell units. Fuel cell units and electrolysis cell units form electrochemical cell units. Fuel cells and electrolysis cells form electrochemical cells.

In the production of a fuel cell unit, layered components of the fuel cells, namely proton exchange membranes, anodes, cathodes, gas diffusion layers and bipolar plates, are stacked to form a stack with fuel cells. The gas diffusion layers are placed on the bipolar plates due to the arrangement. The gas diffusion layers have a low mass and a low specific weight. For this reason, the gas diffusion layers can easily slip after being placed on the bipolar plates, for example due to air currents, so that a relative movement occurs between the gas diffusion layers and the bipolar plates in a direction parallel to fictitious planes spanned by the layered components. This means that after the gas diffusion layers have been placed on the bipolar plates and before a further layered component, for example a membrane electrode arrangement with the anode, cathode and proton exchange membrane, is arranged, a further complex and correct alignment of the gas diffusion layers relative to the bipolar plates is necessary.

### SUMMARY

A method according to the invention for producing an electrochemical cell unit for converting electrochemical energy into electric energy in the form of a fuel cell unit and/or for converting electric energy into electrochemical energy in the form of an electrolysis cell unit, comprising stacked electrochemical cells. The method has the steps of: providing layered components of the electrochemical cells, namely preferably proton exchange membranes, anodes, cathodes, gas diffusion layers, and bipolar plates, and stacking the layered components in order to form electrochemical cells and in order to form a stack of the electrochemical cell unit, wherein the gas diffusion layers are provided such that the gas diffusion layers comprise a magnetic material. The magnetic material with which the gas diffusion layers are provided is, for example, a soft magnetic material, a semi-hard magnetic material or a permanent magnetic material. The bipolar plates made of metal, in particular with iron, are made of a magnetic material, so that a magnetic force occurs between the bipolar plates and the gas diffusion layers, which causes a compressive force between the contact surfaces of the bipolar plates and the gas diffusion layers. This compressive force thereby causes a force-fit and/or form-fit connection between the contact surfaces of the bipolar plates and gas diffusion layers, so that in an advantageous manner no relative movement occurs between the gas diffusion layers and the bipolar plates in a direction parallel to the fictitious planes spanned by the layer-shaped components after the gas diffusion layers have been placed on the bipolar plates. Forces, for example due to air movements, are therefore no longer sufficient to cause a relative movement between the bipolar plates and the gas diffusion layers.

In another variant, the gas diffusion layers are placed on the bipolar plates with a magnetic material so that the gas diffusion layers are attracted to the bipolar plates with a magnetic force.

In a supplementary configuration, the compressive force resulting from the magnetic force at contact surfaces between the gas diffusion layers and the bipolar plates produces a force-fit and/or form-fit connection between the gas diffusion layers and bipolar plates.

In a further embodiment, a gas diffusion layer is placed on each bipolar plate so that the one bipolar plate forms an intermediate mounting unit with the one gas diffusion layer and the gas diffusion layer is attracted to the one bipolar plate by the magnetic force in the intermediate mounting unit. The magnetic force between the gas diffusion layer and the respective bipolar plate in the mounting unit causes a form-fit and/or force-fit connection between the gas diffusion layer and the respective bipolar plate, so that during the movement of the intermediate mounting unit to the already partially stacked stack no relative movement occurs between the gas diffusion layer and the respective bipolar plate in a direction parallel to the fictitious planes spanned by the layer-shaped components gas diffusion layer and bipolar plate. This allows the intermediate mounting unit to be advantageously moved to the partially stacked stack by a robot at high speed, resulting in strong air currents.

A gas diffusion layer and a membrane electrode arrangement are conveniently placed on one bipolar plate each, so that the one bipolar plate forms an intermediate mounting unit with the gas diffusion layer and the membrane electrode arrangement and the gas diffusion layer is attracted to the one bipolar plate with the magnetic force in the intermediate mounting unit.

Preferably, the gas diffusion layer is arranged between the bipolar plate and the membrane electrode arrangement in the intermediate mounting unit.

In a further configuration, two gas diffusion layers and a membrane electrode arrangement are placed on one bipolar plate each, so that the one bipolar plate with the two gas diffusion layers and the membrane electrode arrangement forms an intermediate mounting unit and the gas diffusion layers are attracted to the one bipolar plate each by the magnetic force in the intermediate mounting unit.

In a supplementary variant, a first gas diffusion layer is arranged in the intermediate mounting unit between the bipolar plate and the membrane electrode arrangement, and the membrane electrode arrangement is arranged between the first and a second gas diffusion layer.

In another variant, the intermediate mounting units are produced in an intermediate step and then the intermediate mounting units are placed on an already partially stacked stack with stacked electrochemical cells. Preferably, the intermediate mounting units produced in the intermediate step are moved to the already partially produced stack using a robot.

In a supplementary embodiment, the gas diffusion layers are moved with at least one magnetic gripper during production by attracting the gas diffusion layers with magnetic forces from the magnetic grippers and moving the at least one magnetic gripper by a robot. Preferably, the at least one magnetic gripper comprises an energizable coil as an electromagnet, so that when current is passed through the coil, an electromagnet is present to form a magnetic force between the coil and the gas diffusion layer and to move the gas diffusion layer while the coil is energized and when the coil is switched off, no magnetic force acts between the coil and the gas diffusion layer, so that when the coil is switched off, the gas diffusion layer is deposited or can be deposited on a layer-shaped component, in particular the bipolar plate.

In an additional configuration, the gas diffusion layers are moved to the bipolar plates with at least one magnetic gripper during production and placed on the bipolar plates by attracting the gas diffusion layers with magnetic forces from the at least one magnetic gripper, so that the intermediate mounting units are formed and the at least one magnetic gripper is moved by a robot.

Preferably, the magnetic material in the gas diffusion layers is fullerene as a modification of carbon. Fullerenes are a modification of carbon and have a molecular formula of C₆₀ or C₇₀ for example. The fullerenes are polymerized at a very high pressure, for example more than 10 bar, 40 bar, 50 bar or 100 bar and/or at a high temperature, in particular at least 50° C., 100° C., 200° C. or 500° C., and thus exhibit magnetic properties.

In a further variant, the magnetic material of particles is formed from a magnetic material, in particular ferromagnetic material.

In an additional embodiment, the particles as nanoparticles comprise the material iron, in particular iron oxide, and the nanoparticles are arranged in tubes as nanotubes, in particular in carbon tubes as nanotubes made of carbon. The nanotubes have a diameter of less than 300 nm, 200 nm or 100 nm. Preferably, the nanotubes are made of carbon, boron nitride or titanium dioxide. Preferably, the nanoparticles are made of a paramagnetic iron oxide. The nanotubes have a diameter of between 200 nm and 400 nm. The nanoparticles are conveniently applied in and/or on the nanotubes by means of vapor phase deposition, in particular also on membranes.

Electrochemical cell unit according to the invention for converting electrochemical energy into electrical energy as a fuel cell unit and/or for converting electrical energy into electrochemical energy as an electrolytic cell unit, comprising stacked electrochemical cells and the electrochemical cells each comprise stacked layered components and the components of the electrochemical cells are preferably proton exchange membranes, anodes, cathodes, gas diffusion layers and bipolar plates, wherein the electrochemical cell unit is produced by a method described in this application for industrial property rights and/or the gas diffusion layers comprise a magnetic material so that the gas diffusion layers are attracted to the bipolar plates with a magnetic force.

In a supplementary configuration, the particles of the magnetic material in the gas diffusion layers have a diameter of less than 50 μm, preferably between 10 nm and 30 μm, in particular between 5 nm and 10 μm.

In an additional configuration, the particles of magnetic material are bonded to the gas diffusion layers with a bonding agent and/or adhesive.

Preferably, the membrane electrode arrangements are each formed by a proton exchange membrane, one anode and one cathode, in particular as a CCM (catalyst coated membrane) with catalyst material in the anodes and cathodes.

In a further variant, the electrochemical cell unit comprises at least 50, 100 or 200 stacked electrochemical cells.

In a further variant, the method described in this application for industrial property rights is used to produce an electrochemical cell unit described in this application for industrial property rights.

The invention further comprises a computer program comprising program code means stored on a computer-readable data carrier for carrying out a method described in this patent application when the computer program is executed on a computer or a corresponding computing unit.

The invention also includes a computer program product comprising program code means stored on a computer-readable data carrier for carrying out a method described in this application for industrial property rights when the computer program is executed on a computer or a corresponding computing unit.

In a supplementary configuration, the electrochemical cell unit is a fuel cell unit in the form of a fuel cell stack for converting electrochemical energy into electrical energy and/or an electrolysis cell unit for converting electrical energy into electrochemical energy.

The bipolar plates are conveniently designed as separator plates and an electrical insulation layer, in particular a proton exchange membrane, is arranged between each anode and each cathode and preferably the electrolysis cells each comprise a third duct for the separate passage of a cooling fluid as a third process fluid.

In an additional variant, the electrolysis cell unit is additionally designed as a fuel cell unit, in particular a fuel cell unit described in this property right application, so that the electrolysis cell unit forms a reversible fuel cell unit.

In another variant, the first substance is oxygen and the second substance is hydrogen.

In another variant, the electrolysis cells of the electrolysis cell unit are fuel cells.

In a further variant, the electrochemical cell unit comprises a housing and/or a connection plate. The stack is enclosed by the housing and/or the connection plate.

Fuel cell system according to the invention, in particular for a motor vehicle, comprising a fuel cell unit as a fuel cell stack with fuel cells, a compressed gas reservoir for storing gaseous fuel, a gas conveying device for conveying a gaseous oxidizing agent to the cathodes of the fuel cells, wherein the fuel cell unit is designed as a fuel cell unit and/or electrolysis cell unit described in this application for industrial property rights.

Electrolysis system and/or fuel cell system according to the invention, comprising an electrolysis cell unit as an electrolysis cell stack with electrolysis cells, preferably a compressed gas reservoir for storing gaseous fuel, preferably a gas conveying device for conveying a gaseous oxidizing agent to the cathodes of the fuel cells, a storage reservoir for liquid electrolyte, a pump for conveying the liquid electrolyte, wherein the electrolysis cell unit is designed as an electrolysis cell unit and/or fuel cell unit described in this property right application.

In a further configuration, the fuel cell unit described in this property right application additionally forms an electrolysis cell unit and preferably vice versa.

In a further variant, the electrochemical cell unit, in particular the fuel cell unit and/or the electrolysis cell unit, comprises at least one connecting device, in particular several connecting devices, and clamping elements.

Useful components for electrochemical cells, in particular fuel cells and/or electrolysis cells, are preferably insulation layers, in particular proton exchange membranes, anodes, cathodes, preferably gas diffusion layers and bipolar plates, in particular separator plates.

In a further configuration, the electrochemical cells, in particular fuel cells and/or electrolysis cells, each preferably comprise an insulating layer, in particular a proton exchange membrane, an anode, a cathode, preferably at least one gas diffusion layer and at least one bipolar plate, in particular at least one separator plate.

In a further embodiment, the connection device is designed as a bolt and/or is rod-shaped and/or is designed as a tensioning belt.

The tensioning elements are advantageously designed as clamping plates.

In a further variant, the gas conveying device is designed as a blower and/or a compressor and/or a pressure reservoir with oxidizing agent.

In particular, the electrochemical cell unit, in particular fuel cell unit and/or electrolysis cell unit, comprises at least 3, 4, 5 or 6 connection devices.

In a further configuration, the tensioning elements are plate-shaped and/or disc-shaped and/or planar and/or designed as a grid.

Preferably, the fuel is hydrogen, hydrogen-rich gas, reformate gas, or natural gas.

The fuel cells and/or electrolysis cells are essentially flat and/or disk-shaped.

In a supplementary variant, the oxidizer is air with oxygen or pure oxygen.

Preferably, the fuel cell unit is a PEM fuel cell unit with PEM fuel cells or an SOFC fuel cell unit with SOFC fuel cells or an alkaline fuel cell (AFC).

### BRIEF DESCRIPTION OF THE DRAWINGS

Embodiment examples of the invention are explained in greater detail below with reference to the accompanying drawings. The following are shown:

FIG. 1 a highly simplified exploded view of an electrochemical cell system as a fuel cell system and electrolysis cell system with components of an electrochemical cell as a fuel cell and electrolysis cell,

FIG. 2 a perspective view of part of a fuel cell and electrolysis cell,

FIG. 3 a longitudinal section through electrochemical cells as fuel cells and electrolysis cells,

FIG. 4 a perspective view of an electrochemical cell unit as a fuel cell unit and electrolysis cell unit as a fuel cell stack and electrolysis cell stack,

FIG. 5 a side view of the electrochemical cell unit as a fuel cell unit and electrolysis cell unit as a fuel cell stack and electrolysis cell stack,

FIG. 6 a perspective view of a bipolar plate,

FIG. 7 a side view of a robot,

FIG. 8 a perspective view of a first bipolar plate prior to application of a gas diffusion layer to the bipolar plate,

FIG. 9 a perspective view of the first bipolar plate with the applied gas diffusion layer and a membrane electrode arrangement prior to application to the bipolar plate and gas diffusion layer; and

FIG. 10 a perspective view of the first bipolar plate with the not-illustrated gas diffusion layer and membrane electrode arrangement prior to placing a second bipolar plate on the membrane electrode arrangement the gas diffusion layer and the first bipolar plate with a further, not-illustrated gas diffusion layer disposed at a bottom of the second bipolar plate.

### DETAILED DESCRIPTION

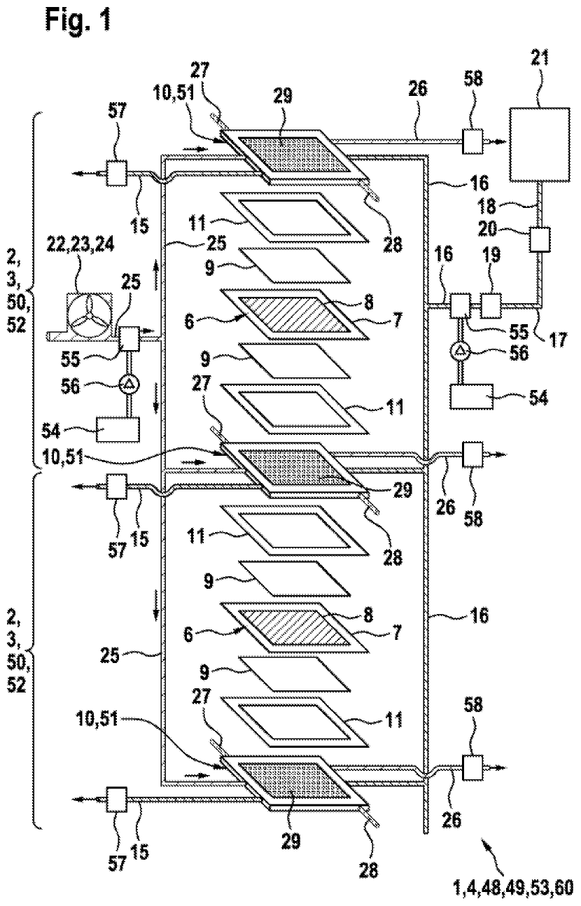

In FIGS. 1 through 3, the basic construction of a fuel cell 2 is shown as a PEM fuel cell 3 (polymer electrolyte fuel cell 3). The principle of fuel cells 2 is that electrical energy or electrical current is generated by means of an electrochemical reaction. Hydrogen H₂ is conducted to an anode 7 as a gaseous fuel, and the anode 7 forms the negative pole. A gaseous oxidant, i.e., air with oxygen, is conducted to a cathode 8, i.e., the oxygen in the air provides the necessary gaseous oxidant. A reduction (electron uptake) takes place on the cathode 8. The oxidation as electron output is performed at the anode 7.

The redox equations of the electrochemical processes are as follows:

$$Cathode :$$

$${O}_{2} + 4 {H}^{+} + 4 {e}^{-} \text{--»} 2 {H}_{2} O$$

$$Anode :$$

$$2 {H}_{2} \text{--»} 4 {H}^{+} + 4 {e}^{-}$$

Summed reaction equation of cathode and anode:

$$2 {H}_{2} + {O}_{2} \text{--»} 2 {H}_{2} O$$

The difference in the normal potentials of the electrode pairs under standard conditions as reversible fuel cell voltage or neutral voltage of the unloaded fuel cell 2 is 1.23 V. This theoretical voltage of 1.23 V is not achieved in practice. At rest and at small currents, voltages above 1.0 V can be achieved and, in operation with larger currents, voltages between 0.5 V and 1.0 V are achieved. The series connection of several fuel cells 2, in particular a fuel cell unit 1 as a fuel cell stack 1 of several stacked fuel cells 2, has a higher voltage, which corresponds to the number of fuel cells 2 multiplied by the individual voltage of each fuel cell 2.

The fuel cell 2 also comprises a proton exchange membrane 5 (PEM), which is arranged between the anode 7 and the cathode 8. The anode 7 and cathode 8 are designed in a layer or disc shape. The PEM 5 functions as an electrolyte, catalyst carrier, and separating device for the reaction gases. The PEM 5 also functions as an electrical insulator and prevents an electrical short circuit between the anode 7 and cathode 8. In general, 12 μm to 150 μm thick, proton-conductive films made of perfluorinated and sulfonated polymers are used. The PEM 5 conducts the protons H⁺ and substantially blocks ions other than protons H⁺ so that charge transport can occur due to the permeability of PEM 5 for the protons H⁺. The PEM 5 is substantially impermeable to the reaction gases oxygen O₂ and hydrogen H₂, i.e. it blocks the flow of oxygen O₂ and hydrogen H₂ between a gas chamber 31 at the anode 7 with fuel hydrogen H₂ and the gas chamber 32 at the cathode 8 with air or Oxygen O₂ as oxidizers. The proton conductivity of the PEM 5 increases with increasing temperature and increasing water content.

On the two sides of the PEM 5, each facing the gas chambers 31, 32, the electrodes 7, 8 are located as the anode 7 and cathode 8. A unit consisting of the PEM 5 and the electrodes 7, 8 is referred to as a membrane electrode arrangement 6 (MEA). The electrodes 7, 8 are pressed together with the PEM 5. The electrodes 7, 8 are platinum-containing carbon particles bonded to PTFE (polytetrafluorethylene), FEP (fluorinated ethylene-propylene copolymer), PFA (perfluoroalkoxy), PVDF (polyvinylidene fluoride), and/or PVA (polyvinyl alcohol) and hot-pressed in microporous carbon fiber, glass fiber, or plastic mats. A catalyst layer 30 is normally applied to each of the electrodes 7, 8 on the side facing the gas chambers 31, 32 (not shown). The catalyst layer 30 no the gas chamber 31 with fuel at the anode 7 comprises nanodispersed platinum ruthenium on graphitized soot particles bonded to a binder. The catalyst layer 30 on the gas chamber 32 with oxidizer on the cathode 8 analogously comprises nanodispersed platinum. For example, binders include Nafion®, a PTFE emulsion, or polyvinyl alcohol.

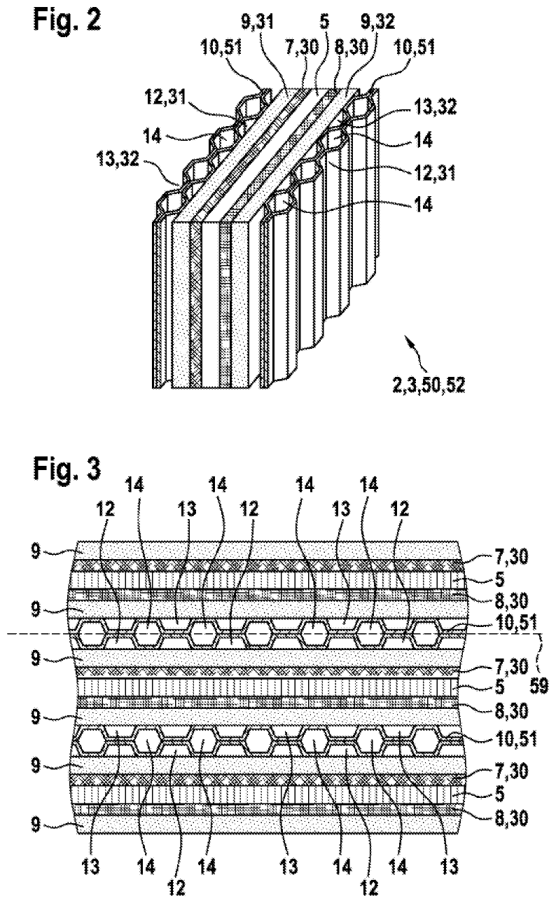

Deviating from this, the electrodes 7, 8 are composed of an ionomer, for example Nafion®, platinum-containing carbon particles and additives. These electrodes 7, 8 with the ionomer are electrically conductive due to the carbon particles and also conduct the protons H⁺ and also act as a catalyst layer 30 (FIGS. 2 and 3) due to the platinum-containing carbon particles. Membrane electrode arrangements 6 with these electrodes 7, 8 comprising the ionomer form membrane electrode arrangements 6 as CCM (catalyst coated membrane).

A gas diffusion layer 9 (GDL) is located on the anode 7 and cathode 8. The gas diffusion layer 9 at the anode 7 evenly distributes the fuel from ducts 12 for fuel to the catalyst layer 30 at the anode 7. The gas diffusion layer 9 on the cathode 8 evenly distributes the oxidizer from ducts 13 for oxidizer onto the catalyst layer 30 at the cathode 8. The GDL 9 also draws reaction water counter to the direction of flow of the reaction gases, i.e. in a direction from the catalyst layer 30 to the ducts 12, 13. Furthermore, the GDL 9 keeps the PEM 5 moist and conducts the power. The GDL 9, for example, is composed of a hydrophobized carbon paper as a carrier and substrate layer and a bonded carbon powder layer as a microporous layer.

A bipolar plate 10 lies atop the GDL 9. The electrically conductive bipolar plate 10 serves as a current collector, for draining water and for conducting the reaction gases as process fluids through the duct structures 29 and/or flow fields 29 and for dissipating the waste heat, which occurs in particular during the exothermic electrochemical reaction at the cathode 8. To dissipate the waste heat, ducts 14 are incorporated into the bipolar plate 10 as a duct structure 29 for the passage of a liquid or gaseous coolant as a process fluid. The duct structure 29 on the gas chamber 31 for fuel is formed by ducts 12. The duct structure 29 on the gas chamber 32 for oxidizers is formed by ducts 13. The materials used for the bipolar plates 10 include metal, conductive plastics and composite materials and/or graphite.

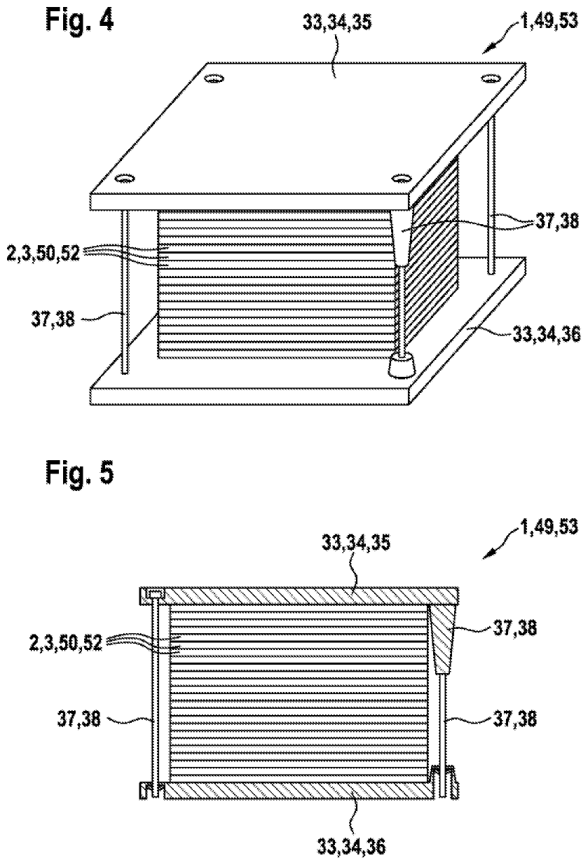

In a fuel cell unit 1 and/or a fuel cell stack 1 and/or a fuel cell stack 1, several fuel cells 2 are arranged so to as to be stacked in alignment (FIGS. 4 and 5). FIG. 1 shows an exploded view of two fuel cells 2 arranged in an aligned stack. Sealing gaskets 11 seal the gas chambers 31, 32 or ducts 12, 13 in a fluid-tight manner. In a compressed gas reservoir 21 (FIG. 1), hydrogen H₂ is stored as a fuel at a pressure of, e.g., 350 bar to 700 bar. From the compressed gas reservoir 21, the fuel is conducted through a high pressure conduit 18 to a pressure reducer 20 in order to reduce the pressure of the fuel in a medium pressure conduit 17 of about 10 bar to 20 bar. From the medium pressure conduit 17, the fuel is conducted towards an injector 19. At the injector 19, the pressure of the fuel is reduced to an injection pressure of between 1 bar and 3 bar. From the injector 19, the fuel is supplied to a fuel supply conduit 16 (FIG. 1) and from the supply conduit 16 to the fuel ducts 12 forming the duct structure 29 for fuel. As a result, the fuel passes through the gas chamber 31 for the fuel. The gas chamber 31 for the fuel is formed by the ducts 12 and the GDL 9 at the anode 7. After passing through the ducts 12, the fuel not consumed in the redox reaction at the anode 7 (and optionally water) are discharged from a controlled humidification means of the anode 7 via a discharge conduit 15 from the fuel cells 2.

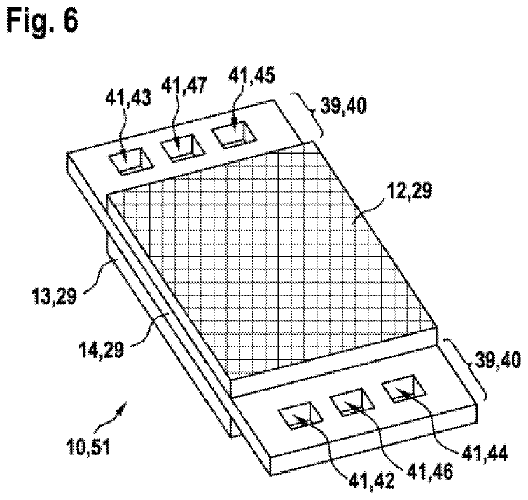

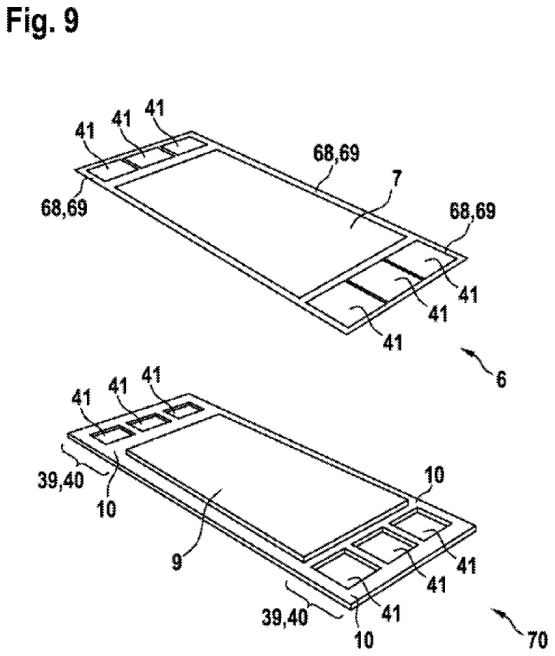

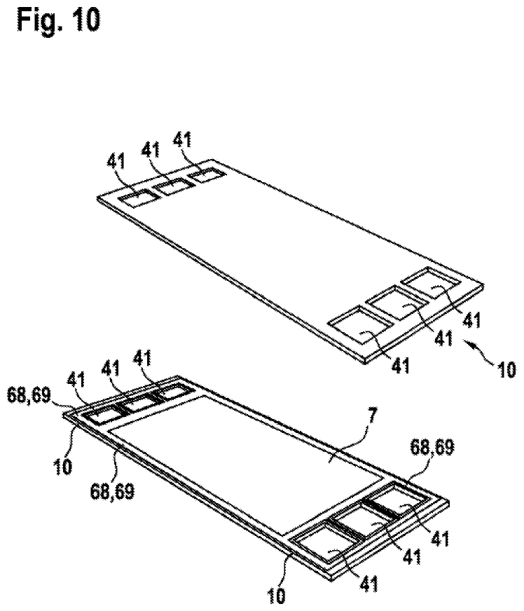

A gas conveying device 22, designed as, e.g., a blower 23 or a compressor 24, conveys air from the surroundings as an oxidizer into an oxidizer supply conduit 25. From the supply conduit 25, the air is supplied to the oxidizer ducts 13, which form a duct structure 29 on the bipolar plates 10 for oxidizers such that the oxidizer passes through the gas chamber 32 for the oxidizer. The gas chamber 32 for the oxidizer is formed by the ducts 13 and the GDL 9 on the cathode 8. After passing through the ducts 13 or the gas chamber 32 for the oxidizer 32, the oxidizer not consumed on the cathode 8 and the reaction water resulting on the cathode 8 due to the electrochemical redox reaction are discharged from the fuel cells 2 through a discharge conduit 26. A supply conduit 27 is used to supply coolant into the ducts 14 for coolant, and a discharge conduit 28 is used to discharge coolant conducted through the ducts 14. The supply and discharge conduits 15, 16, 25, 26, 27, 28 are shown as separate conduits in FIG. 1 for reasons of simplification. At the end region in the vicinity of the ducts 12, 13, 14, fluid openings 41 are formed in the stack as a stack of the fuel cell unit 1 on sealing plates 39 as an extension at the end region 40 of the bipolar plates 10 (FIG. 6) and membrane electrode arrangements 6 (FIGS. 9 and 10) lying on top of one another. The fuel cells 2 and the components of the fuel cells 2 are disk-shaped and span fictitious planes 59 that are essentially parallel to one another. The aligned fluid openings 41 and sealing gaskets (not shown) in a direction perpendicular to the fictitious planes 59 between the fluid openings 41 thus form a supply duct 42 for oxidizing agent, a discharge duct 43 for oxidizing agent, a supply duct 44 for fuel, a discharge duct 45 for fuel, a supply duct 46 for coolant and a discharge duct 47 for coolant. The supply and discharge conduits 15, 16, 25, 26, 27, 28 outside the stack of the fuel cell unit 1 are designed as process fluid conduits. The supply and discharge conduits 15, 16, 25, 26, 27, 28 outside the stack of the fuel cell unit 1 open into the supply and discharge ducts 42, 43, 44, 45, 46, 47 inside the stack of the fuel cell unit 1. The fuel cell stack 1, together with the compressed gas reservoir 21 and the gas conveying device 22, form a fuel cell system 4.

In the fuel cell unit 1, the fuel cells 2 are arranged between two clamping elements 33 as clamping plates 34. A first clamping plate 35 rests on the first fuel cell 2 and a second clamping plate 36 rests on the last fuel cell 2. The fuel cell unit 1 comprises approximately 200 to 400 fuel cells 2, not all of which are shown in FIGS. 4 and 5 for graphic reasons. The clamping elements 33 apply a compressive force to the fuel cells 2, i.e. the first clamping plate 35 rests with a compressive force on the first fuel cell 2 and the second clamping plate 36 rests with a compressive force on the last fuel cell 2. The fuel cell stack 2 is thus braced to ensure tightness for the fuel, the oxidizing agent and the coolant, in particular due to the elastic sealing gaskets 11, and also to keep the electrical contact resistance within the fuel cell stack 1 as low as possible. To clamp the fuel cells 2 with the clamping elements 33, four connection devices 37 are designed on the fuel cell unit 1 as bolts 38, which are tensioned. The four bolts 38 are connected to the clamping plates 34.

FIG. 6 shows the bipolar plate 10 of the fuel cell 2. The bipolar plate 10 comprises the ducts 12, 13 and 14 as three separate duct structures 29. The ducts 12, 13 and 14 are not shown separately in FIG. 6, but merely simplified as a layer of a duct structure 29. The fluid openings 41 on the sealing plates 39 of the bipolar plates 10 and membrane electrode arrangements 6 (FIGS. 9 and 10) are stacked in alignment within the fuel cell unit 1, so that supply and discharge ducts 42, 43, 44, 45, 46, 47 are formed. Sealing gaskets not shown are arranged between the sealing plates 39 for fluid-tight sealing of the supply and discharge ducts 42, 43, 44, 45, 46, 47 formed by the fluid openings 41.

Since the bipolar plate 10 also separates the gas chamber 31 for fuel from the gas chamber 32 for oxidizing agent in a fluid-tight manner and also seals the duct 14 for coolant in a fluid-tight manner, the term separator plate 51 can also be selected for the bipolar plate 10 for the fluid-tight decomposition or separation of process fluids. This means that the term bipolar plate 10 also includes the term separator plate 51 and vice versa. The ducts 12 for fuel, the ducts 13 for oxidizing agent and the ducts 14 for coolant of the fuel cell 2 are also formed on the electrochemical cell 52, but with a different function.

The fuel cell unit 1 can also be used and operated as an electrolysis cell unit 49, i.e. it forms a reversible fuel cell unit 1. In the following, some features are described which enable the fuel cell unit 1 to be operated as an electrolysis cell unit 49. A liquid electrolyte, namely highly diluted sulphuric acid with a concentration of approximately c (H₂SO₄)=1 mol/l, is used for electrolysis. A sufficient concentration of oxonium ions H₃0⁺ in the liquid electrolyte is necessary for electrolysis.

The following redox reactions take place during electrolysis:

$$Cathode :$$

$$4 {H}_{3} {O}^{+} + 4 {e}^{-} \text{--»} 2 {H}_{2} + 4 {H}_{2} O$$

$$Anode :$$

$$6 {H}_{2} O \text{--»} {O}_{2} + 4 {H}_{3} {O}^{+} + 4 {e}^{-}$$

Summed reaction equation of cathode and anode:

$${H}_{2} O \text{--»} {2H}_{2} + {O}_{2}$$

The polarity of the electrodes 7, 8 is reversed with electrolysis during operation as an electrolysis cell unit 49 (not shown) as during operation as a fuel cell unit 1, so that hydrogen H₂ is formed as a second substance at the cathodes in the ducts 12 for fuel, through which the liquid electrolyte is passed, and the hydrogen H₂ is absorbed by the liquid electrolyte and transported in solution. Similarly, the liquid electrolyte is fed through the ducts 13 for oxidizing agents and oxygen O₂ is formed as the first substance at the anodes in or at ducts 13 for oxidizing agents. The fuel cells 2 of the fuel cell unit 1 function as electrolysis cells 50 during operation as electrolysis cell unit 49. The fuel cells 2 and electrolysis cells 50 thus form electrochemical cells 52. The oxygen O₂ formed is absorbed by the liquid electrolyte and transported in solution. The liquid electrolyte is stored in a storage reservoir 54. For reasons of simplification, FIG. 1 shows two storage reservoirs 54 of the fuel cell system 4, which also functions as an electrolysis cell system 48. The 3-way valve 55 on the supply conduit 16 for fuel is switched over during operation as an electrolysis cell unit 49, so that the liquid electrolyte is fed into the supply conduit 16 for fuel by a pump 56 from the storage reservoir 54 rather than fuel from the compressed gas reservoir 21. A 3-way valve 55 on the supply conduit 25 for oxidizing agent is switched over during operation as electrolysis cell unit 49, so that the liquid electrolyte is fed into the supply conduit 25 for oxidizing agent by the pump 56 from the storage reservoir 54 rather than oxidizing agent as air from the gas conveying device 22. The fuel cell unit 1, which also functions as an electrolysis cell unit 49, has optional modifications to the electrodes 7, 8 and the gas diffusion layer 9 compared to a fuel cell unit 1 that can only be operated as a fuel cell unit 1: for example, the gas diffusion layer 9 is not absorbent, so that the liquid electrolyte easily runs off completely, or the gas diffusion layer 9 is not formed, or the gas diffusion layer 9 is a structure on the bipolar plate 10. The electrolysis cell unit 49 with the storage reservoir 54, the pump 56 and the separators 57, 58 and preferably the 3-way valve 55 forms an electrochemical cell system 60.

A separator 57 for hydrogen is arranged on the discharge conduit 15 for fuel. The separator 57 separates the hydrogen from the electrolyte with hydrogen and the separated hydrogen is fed into the compressed gas reservoir 21 by a compressor not shown. The electrolyte drained from the separator 57 for hydrogen is then fed back to the storage reservoir 54 for the electrolyte via a conduit. A separator 58 for oxygen is arranged on the discharge conduit 26 for fuel. The separator 58 separates the oxygen from the electrolyte with oxygen and the separated oxygen is fed into a compressed gas reservoir for oxygen, not shown, using a compressor, not shown. The oxygen in the compressed gas reservoir for oxygen, which is not shown, can optionally be used for the operation of the fuel cell unit 1 by sliding the oxygen into the supply conduit 25 for oxidizing agent with a conduit, which is not shown, during operation as fuel cell unit 1. The electrolyte drained from the separator 58 for oxygen is then fed back to the storage reservoir 54 for the electrolyte via a conduit. The ducts 12, 13 and the discharge and supply conduits 15, 16, 25, 26 are designed in such a way that after use as an electrolysis cell unit 49 and the pump 56 is switched off, the liquid electrolyte runs back completely into the storage reservoir 54 due to gravity. Optionally, after use as an electrolysis cell unit 49 and before use as a fuel cell unit 1, an inert gas is passed through the ducts 12, 13 and the discharge and supply conduits 15, 16, 25, 26 to completely remove the liquid electrolyte before the gaseous fuel and oxidizing agent are passed through. The fuel cells 2 and the electrolysis cells 2 thus form electrochemical cells 52. The fuel cell unit 1 and the electrolysis cell unit 49 thus form an electrochemical cell unit 53. The ducts 12 for fuel and the ducts for oxidizing agent thus form ducts 12, 13 for the passage of the liquid electrolyte during operation as an electrolysis cell unit 49 and this applies analogously to the supply and discharge conduits 15, 16, 25, 26. For process-related reasons, an electrolysis cell unit 49 does not normally require ducts 14 for the passage of coolant. In an electrochemical cell unit 49, the ducts 12 for fuel also form ducts 12 for passing fuel and/or electrolytes and the ducts 13 for oxidizing agents also form ducts 13 for passing fuel and/or electrolytes.

In another embodiment example, not shown, the fuel cell unit 1 is designed as an alkaline fuel cell unit 1. Potassium hydroxide solution is used as a mobile electrolyte. The fuel cells 2 are arranged in a stack. A monopolar cell structure or a bipolar cell structure can be formed. The potassium hydroxide solution circulates between an anode and cathode and removes reaction water, heat and impurities (carbonates, dissolved gases). The fuel cell unit 1 can also be operated as a reversible fuel cell unit 1, i.e. as an electrolysis cell unit 49.

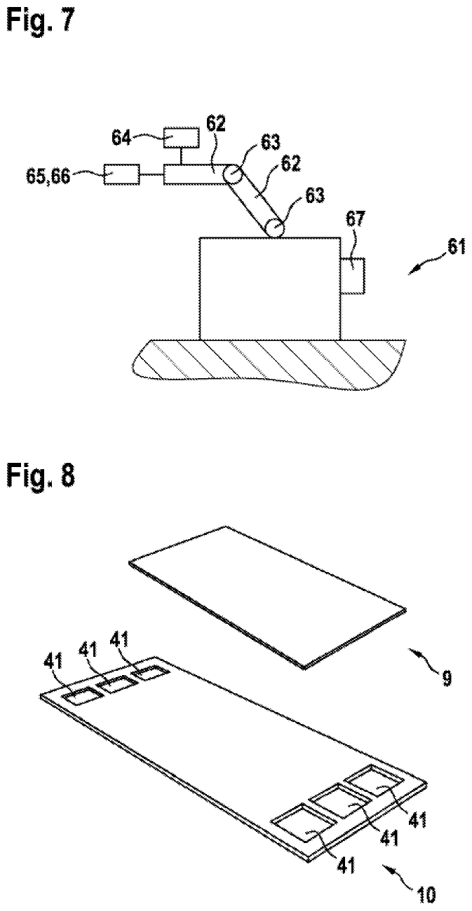

FIG. 7 shows a robot 61 for producing the electrochemical cell unit 53. The robot 61 comprises robot arms 62 and robot joints 63. A process unit 65 in the form of a magnetic gripper 66 and a camera 64 are attached to one end section of a final robot arm 62. The magnetic gripper 66 with a coil as electromagnet is attached to the last robot arm 62 with a motorized movable ball joint (not shown). A computer 67 with a processor and a data memory controls the robot 61. Position data on the intended geometric arrangement of the bipolar plates 10 and/or gas diffusion layers 9 and/or proton exchange membranes 5 and/or membrane electrode arrangements 6 and/or on the relative position of the robot 61 to the stack of the electrochemical cell unit 53 are stored in the data memory. The camera 64 optically captures images of the bipolar plates 10 and/or gas diffusion layers 9 and/or proton exchange membranes 5 and/or membrane electrode arrays 6, and image processing software in the computer 67 is used to capture the actual relative position of the bipolar plates 10 and/or gas diffusion layers 9 and/or proton exchange membranes 5 and/or membrane electrode arrays 6 to the robot 48. The movement of the robot 61 is thus controlled as a function of the intended position data stored in the data memory and/or the data determined by the image processing software for the actual position of the bipolar plates 10 and/or gas diffusion layers 9 and/or proton exchange membranes 5 and/or membrane electrode arrangements 6 relative to the robot 48. The stored position data can thus be corrected with the data determined by the image processing software for the actual position of the bipolar plates 10 and/or gas diffusion layers 9 and/or proton exchange membranes 5 and/or membrane electrode arrangements 6 relative to the robot 61, so that in an advantageous manner deviations in the geometric arrangement of the bipolar plates 10 and/or gas diffusion layers 9 and/or proton exchange membranes 5 and/or membrane electrode arrangements 6, for example due to manufacturing inaccuracies, have no effect on the production. In addition, the robot 61 has a mechanical gripper, which is not shown.

For the production of an electrochemical cell unit 53, the layered components of electrochemical cells 52 are provided first. The layered components are, for example, a proton exchange membrane 5, an anode 7, a cathode 8, a gas diffusion layer 9 and a bipolar plate 10 in a fuel cell unit 1. Thereby the anode 7, the cathode 8 and the proton exchange membrane 5 form a membrane electrode arrangement 6 in which in the anode 7 and the cathode 8 CCM (catalyst coated membrane) in which the anode 7 and the cathode 8 are additionally provided with a catalyst material, so that the anode 7 and the cathode 8 additionally form a catalyst layer 30. The layered components of the fuel cells 2 are stacked to form a stack, for example as shown in FIGS. 3 and 4.

The gas diffusion layers 9 are produced and provided in such a way that they have magnetic properties. This is achieved by the fact that the gas diffusion layers 9 are partially provided with a magnetic material as particles. These particles as nanoparticles are arranged in carbon tubes as nanotubes. Alternatively or additionally, fullerenes can also be arranged in the gas diffusion layers 9 as a modification of carbon as a magnetic material. The bipolar plates 10 are essentially made of iron and are therefore also made of a magnetic material.

FIG. 8 shows a production step for producing an intermediate mounting unit 70 from the bipolar plate 10 and the gas diffusion layer 9. To produce the intermediate mounting unit 70, the robot 61 uses a mechanical gripper or a suction gripper (not shown) to place a bipolar plate 10 from an undisplayed stack of bipolar plates 10 onto an undisplayed support surface. The robot 61 then uses the magnetic gripper 66 to lift a gas diffusion layer 9 from a stack of gas diffusion layers 9 (not shown) by energizing a coil (not shown) in the magnetic gripper 66, so that magnetic forces are formed with the aid of which the gas diffusion layer 9 can be lifted due to magnetic forces between the magnetic gripper 66 as an electromagnet with the energized coil on the one hand and the magnetic material in the gas diffusion layer 9 on the other. Several robots 61 are used or several magnetic grippers 66 are generally arranged on one robot 61 on a corresponding linkage. The gas diffusion layer 9 can thus simply be placed on the bipolar plate 10 without causing mechanical damage to the gas diffusion layer 9, so that the gas diffusion layer 9 is placed on an upper side of the bipolar plate 10 as shown in FIG. 9.

This intermediate mounting unit 70 shown in FIG. 9 can optionally be moved to an already partially produced stack of the fuel cell unit 1 with the robot 61, for example by means of mechanical grippers and/or the magnetic grippers 66. FIG. 9 also shows the membrane electrode arrangement 6. In the membrane electrode arrangement 6, the proton exchange membrane 5 is enclosed by a sealing layer 68 as a subgasket 69. The fluid openings 41 are also formed in the subgasket 69. The membrane electrode arrangement 6 in FIG. 10 forms a CCM because catalyst material is incorporated into the anode 7 and the cathode 8. In a further step, the membrane electrode arrangement 6 is placed on the gas diffusion layer 9 and on the bipolar plate 10, so that the gas diffusion layer 9 is arranged between the membrane electrode arrangement 6 and the bipolar plate 10 as shown in the illustration of the intermediate mounting unit 70 in FIG. 10. In FIG. 10, the intermediate mounting unit 70 thus comprises the bipolar plate 10, the gas diffusion layer 9 and the membrane electrode arrangement 6. Optionally, this intermediate mounting unit 70 can be moved to the already partially formed stack with the fuel cells 2 by means of the robot 61.

Deviating from this, a further second bipolar plate 10 can also be placed on the intermediate mounting unit 70 shown in FIG. 10 below with the bipolar plate 10, the gas diffusion layer 9 and the membrane electrode arrangement 6. In the upper second bipolar plate 10 shown in FIG. 10, a further second gas diffusion layer 9 lies on the underside of the bipolar plate 10, which is not shown. The second gas diffusion layer 9 is attached to the bipolar plate 10 by magnetic forces between the gas diffusion layer 9 and the bipolar plate 10. This was achieved, for example, by the robot 61 applying a gas diffusion layer 9 to this underside of the bipolar plate 10 and then using another robot 61 to rotate this bipolar plate 10 with the applied gas diffusion layer 9 by 180° to the position in FIG. 10 and then using this other robot 61 to apply the bipolar plate 10 with the gas diffusion layer 9 resting on the bottom to the intermediate mounting unit 70 shown in FIG. 10. This forms a further larger intermediate mounting unit 70, comprising the first and second bipolar plates 10 on the outside of this intermediate mounting unit 70 as well as the two gas diffusion layers 9 and the membrane electrode arrangement 6 as CCM, which is arranged between the two gas diffusion layers 9. This intermediate mounting unit 70 is then moved with the robot 61 and magnetic grippers 66 and/or mechanical grippers to the only partially stacked pile with the fuel cells 2. These processes described above are repeated again and again until, for example, a fuel cell unit 1 is produced as a stack of 400 fuel cells 2.

The processes described above can also be used in an analogous manner to produce an electrochemical cell unit 49.

Overall, the method according to the invention for producing the electrochemical cell unit 53 and the electrochemical cell unit 53 according to the invention have significant advantages. Due to the magnetic material in the gas diffusion layers 9, the gas diffusion layers 9 can be temporarily fixed to the magnetic grippers 66 of the robot 61 and, in addition, the magnetic forces occur between the bipolar plates 10 made of steel or iron and the gas diffusion layers 9. The gas diffusion layers 9, which are very sensitive to mechanical damage, can thus be moved in a non-destructive and reliable manner by the magnetic grippers 66 during the entire production method by means of the robot 61 without the use of mechanical grippers. Mechanical grippers have a high risk of mechanical damage to the sensitive gas diffusion layers 9. Furthermore, the magnetic forces between the bipolar plates 10 and the gas diffusion layers 9 after the gas diffusion layers 9 have been placed on the bipolar plates 10 ensure the exclusion of a relative movement between the gas diffusion layers 9 and the bipolar plates 10 in a direction parallel to the fictitious planes 59. In this way, intermediate mounting units 70 can be advantageously moved in space by the robot 61 with the bipolar plate 10 and the gas diffusion layer 9 at a high speed without the resulting air movement triggering a relative movement between the bipolar plate 10 and the gas diffusion layer 9. Readjustment of gas diffusion layers 9 already placed on the bipolar plate 10 is therefore advantageously no longer necessary. In addition, the gas diffusion layers 9 can also be fixed to an underside of the bipolar plate 10 by means of magnetic forces in order to optimize the production method. Overall, this enables safe, reliable, cost-effective and precise production of electrochemical cell units 53.

1. A method of producing an electrochemical cell unit (53) for converting electrochemical energy into electrical energy as a fuel cell unit (1) and/or for converting electrical energy into electrochemical energy as an electrolysis cell unit (49) with stacked electrochemical cells (52), comprising the steps of:
providing layered components (5, 6, 7, 8, 9, 10, 30, 51) of the electrochemical cells (52), the layered components including proton exchange membranes (5), anodes (7), cathodes (8), gas diffusion layers (9) and bipolar plates (10),
stacking of the layered components (5, 6, 7, 8, 9, 10, 30, 51) to form electrochemical cells (52) and a stack of the electrochemical cell unit (53),
wherein
the gas diffusion layers (9) comprise a magnetic material.

2. The method according to claim 1,
wherein
the gas diffusion layers (9) are placed on the bipolar plates (10) with a magnetic material so that the gas diffusion layers (9) are attracted to the bipolar plates (10) with a magnetic force.

3. The method according to claim 2,
wherein
a force-fit and/or form-fit connection is produced between the gas diffusion layers (9) and bipolar plates (10) due to a compressive force resulting from the magnetic force at contact surfaces between the gas diffusion layers (9) and bipolar plates (10).

4. The method according to claim 1,
wherein
a gas diffusion layer (9) is placed on one bipolar plate (10), so that the one bipolar plate (10) forms an intermediate mounting unit (70) with the gas diffusion layer (9) and the gas diffusion layer (9) is attracted to the one bipolar plate (10) by a magnetic force in the intermediate mounting unit (70).

5. The method according to claim 1,
wherein
a gas diffusion layer (9) and a membrane electrode arrangement (6) are placed on a respective bipolar plate (10), so that the respective bipolar plate (10) forms an intermediate mounting unit (70) with the gas diffusion layer (9) and the membrane electrode arrangement (6) and the gas diffusion layer (9) is attracted to the respective bipolar plate (10) by a magnetic force in the intermediate mounting unit (70).

6. The method according to claim 5,
wherein
in the intermediate mounting unit (70), the gas diffusion layer (9) is arranged between the bipolar plate (10) and the membrane electrode arrangement (6).

7. The method according to claim 1,
wherein
two gas diffusion layers (9) and a membrane electrode arrangement (6) are placed on one bipolar plate (10), so that the one bipolar plate (10) with the two gas diffusion layers (9) and the membrane electrode arrangement (6) form an intermediate mounting unit (70) and in the intermediate mounting unit (70) the gas diffusion layers (9) are attracted to the one bipolar plate (10) each by a magnetic force.

8. The method according to claim 7,
wherein
a first gas diffusion layer (9) is arranged in the intermediate mounting unit (70) between the bipolar plate (10) and the membrane electrode arrangement (6), and the membrane electrode arrangement (6) is arranged between the first and a second gas diffusion layer (9).

9. The method according to claim 4,
wherein
the intermediate mounting units (70) are produced in an intermediate step and then the intermediate mounting units (70) are placed on an already partially stacked stack with stacked electrochemical cells (52).

10. The method according to claim 1,
wherein
the gas diffusion layers (9) are moved with at least one magnetic gripper (66) during production by attracting the gas diffusion layers (9) with magnetic forces from the magnetic grippers (66) and the at least one magnetic gripper (66) is moved by a robot (61).

11. The method according to claim 1,
wherein
the gas diffusion layers (9) are moved with at least one magnetic gripper (66) to the bipolar plates (10) during production and placed on the bipolar plates (10) by attracting the gas diffusion layers (9) with magnetic forces from the at least one magnetic gripper (66), so that intermediate mounting units (70) are formed and the at least one magnetic gripper (66) is moved by a robot (61).

12. The method according to claim 1,
wherein
the magnetic material in the gas diffusion layers (9) is fullerene as a modification of carbon.

13. The method according to claim 1,
wherein
the magnetic material includes particles formed from a ferromagnetic material.

14. The method according to claim 13,
wherein
the particles are nanoparticles that comprise iron, and the nanoparticles are arranged in tubes as nanotubes.

15. An electrochemical cell unit (53) for converting electrochemical energy into electrical energy as a fuel cell unit (2) and/or for converting electrical energy into electrochemical energy as an electrolysis cell unit (49), comprising
stacked electrochemical cells (52) and the electrochemical cells (52) each comprise stacked layered components (5, 6, 7, 8, 9, 10, 51), and
the components (5, 6, 7, 8, 9, 10, 51) of the electrochemical cells (52) including proton exchange membranes (5), anodes (7), cathodes (8), gas diffusion layers (9) and bipolar plates (10, 51),
wherein
the electrochemical cell unit (53) is produced by a method according to claim 1
and/or
the gas diffusion layers (9) comprise a magnetic material so that the gas diffusion layers (9) are attracted to the bipolar plates (10) with a magnetic force.

16. The method according to claim 14, wherein the iron includes iron oxide.

17. The method according to claim 14, wherein the tubes as nanotubes include carbon tubes as nanotubes of carbon.
